(19) United States
(12) Patent Application Publication
(10) Pub. No.: US 2026/0136242 A1
(43) Pub. Date: May 14, 2026

(54) RECEPTION OF DATA ON A SOURCE CELL DURING HANDOVER PROCEDURE

(71) Applicant: Nokia Technologies Oy, Espoo (FI)

(72) Inventors: Janne Veikko KAASALAINEN, Soderkulla (FI); Rakash SIVASIVA GANESAN, Aschaffenburg (DE); Ahmad AWADA, Munich (DE); Halit Murat GÜRSU, Munich (DE); Lars DALSGAARD, Oulu (FI); Subramanya CHANDRASHEKAR, Bangalore (IN)

(21) Appl. No.: 19/118,494

(22) PCT Filed: Sep. 18, 2023
(86) PCT No.: PCT/EP2023/075627

§ 371 Date: Apr. 4, 2025

(30) Foreign Application Priority Data
Oct. 5, 2022 (GB) 2214639.3

(51) Int. Cl. H04W 36/00; H04W 56/00; H04W 74/0833

(52) U.S. Cl. CPC H04W 36/0016; H04W 56/0045; H04W 74/0833

(57) ABSTRACT

Systems, methods, apparatuses, and computer program products for a handover interruption time reduction through data reception on a source cell during a handover procedure are provided. For example, a method can include receiving a gap allocation configuration at a user equipment from a network. The method can also include preparing for a handover to a target cell during a gap according to the gap allocation.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to a handover interruption time reduction through data reception on a source cell during a handover procedure.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to a terminal device. The terminal device can include at least one processor and at least memory storing instructions. The instructions, when executed by the at least one processor, can cause the terminal device at least to perform receiving a gap allocation configuration from a network. The instructions, when executed by the at least one processor, can also cause the terminal device at least to perform preparing for a handover to a target cell during a gap according to the gap allocation.

An embodiment may be directed to an apparatus. The apparatus can include at least one processor and at least memory storing instructions. The instructions, when executed by the at least one processor, can cause the apparatus at least to perform determining that a user equipment is to undergo handover to a target cell. The instructions, when executed by the at least one processor, can also cause the apparatus at least to perform obtaining a gap allocation to be configured to the user equipment based on the determination. The instructions, when executed by the at least one processor, can further cause the apparatus at least to perform configuring the gap allocation to the user equipment.

An embodiment may be directed to a method. The method can include receiving, at a terminal device, a gap allocation configuration from a network. The method can also include preparing, by the terminal device, for a handover to a target cell during a gap according to the gap allocation.

An embodiment may be directed to a method. The method can include determining, at an access network element, that a user equipment is to undergo handover to a target cell. The method can also include obtaining, by the access network element, a gap allocation to be configured to the user equipment based on the determination. The method can further include configuring, by the access network element, the gap allocation to the user equipment.

An embodiment can be directed to a terminal device. The terminal device can include means for receiving a gap allocation configuration from a network. The terminal device can also include means for preparing for a handover to a target cell during a gap according to the gap allocation.

An embodiment can be directed to an apparatus. The apparatus can include means for determining that a user equipment is to undergo handover to a target cell. The apparatus can also include means for obtaining a gap allocation to be configured to the user equipment based on the determination. The apparatus can further include means for configuring the gap allocation to the user equipment.

### BRIEF DESCRIPTION OF THE DRAWINGS

For proper understanding of example embodiments, reference should be made to the accompanying drawings, wherein:

FIG. 1 illustrates estimates of handover interruption time for various types of handovers;

FIG. 2 illustrates a signaling flow diagram to configure a dynamic gap for a user equipment, according to certain embodiments;

FIG. 3 illustrates a signal flow diagram illustrating various aspects of certain embodiments;

FIG. 4 illustrates a method according to certain embodiments;

FIG. 5 illustrates another method according to certain embodiments; and

FIG. 6 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing a handover interruption time reduction through data reception on a source cell during a handover procedure, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Handover (HO) can occur multiple times in a wireless communication system, particularly when a user equipment (UE) moves or radio conditions in an area change. HO can lead to a variety of issues including interruption of user plane (UP). Certain embodiments may relate to user plane interruption reduction during HO, which may lead other benefits, such as power savings and signaling reduction that might otherwise be required if user plane interruption occurred during handover.

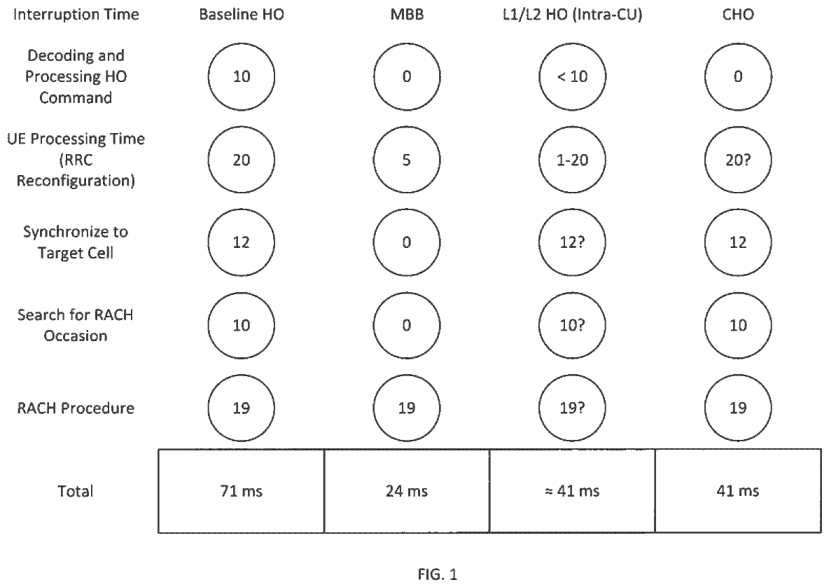

FIG. 1 illustrates estimates of handover interruption time for various types of handovers. In a baseline handover, estimated interruption time is the longest of the example, at 71 ms. In that case, interruption time can include interruptions from handover command reception until the UE is fully connected to the new cell with a random access channel (RACH) procedure. In layer 1 (L1) and layer 2 (L1/L2) mobility intra-central unit (CU), this interruption time can be reduced by doing part of the preparation before actual handover. For example, handover preparation can be started with multiple candidates, and the handover can be triggered to one of the candidate target cell is based on L1/L2 measurement by sending a lower layer message. In this case, the UE may have time to decode RRC messages and may not need additional time for such activities when the UE is triggered to perform the handover. The same applies as well for conditional handover (CHO).

L1/L2 mobility may improve interruption time, but interruption time may still be significant when random access needs to be performed with respect to the target cell. In certain embodiments, a method can reduce the interruption. Even though certain embodiments are described from the point of view of L1/L2 handover, certain embodiments may be applied to any type of handover.

As also shown in FIG. 1, a make before break (MBB) procedure may result in a 24 ms interruption. In this case, the main component contributing to the interruption time may be the RACH procedure. Certain embodiments can complement MBB to reduce the interruption during the RACH procedure.

In certain embodiments, the network can configure the UE with dynamic scheduling gaps as assistance information based on the network's estimation about the next scheduling cycle. The UE can then use this gap assistance information to synchronize to the target cell, search RACH occasions of the target cell or even do RACH procedure. Once UE has completed these procedures, the UE can indicate to the source node that the source cell can initiate the handover and can stop user plane procedures. This way the UE can receive and transmit uninterrupted data on the source side until the very last moment before UE moves to the new cell, by avoiding performing the above mentioned functions at the time of handover. Specifically, synchronize to the target cell and search RACH occasions of the target cell can be done before user plane interruption occurs.

Certain embodiments may have various aspects. For example, the source radio access network (RAN) node, which may be referred to as a base station, can determine that a UE has to undergo handover over to a target cell. The source RAN node can obtain the gap allocation or suggestion from the source RAN's own medium access control (MAC) probabilistic scheduler (MAC-PS) and optionally a contention free random access (CFRA) preamble allocation related to RACHless HO from the target RAN.

In case of a disaggregated next generation (NG) RAN (NG-RAN) node, the central unit (CU) control plane (CU-CP) can obtain the scheduling gap from the source distributed unit (DU) where MAC-PS resides in an F1:UE context setup or modification procedure and the CFRA preamble from the target DU.

In case of a centralized NG-RAN node, the gNB can obtain the scheduling gap from the peer gNB in the handover request acknowledgement over an Xn interface. In this discussion, obtaining the scheduling gap can refer to obtaining information regarding when the scheduling gap will occur or should occur.

The Source NG-RAN node can configure the UL gap allocation or suggestion to the UE using an RRCReconfiguration message. This message may also include the timing advance information for the target cell. When the NG-RAN node indicates that the UE is about to undergo handover, the UE can use the configured scheduling gap and the provided CFRA preamble to search and transmit a preamble corresponding to the RACH occasions of the target cell. The NG-RAN can indicate that the UE is about to undergo handover using a DL MAC CE in case of lower layer mobility.

Once the UE acquires the timing advance information, the UE can initiate a validity timer for the timing advance. The parameters for the expiry of the timer can be configured by the network. The timer can be stopped if the UE performs access to the target cell while the timing advance is valid. If the timer expires, UE can indicate that the timer expired or that the timing advance is no longer valid to the network and can re-obtain the timing advance.

As another option, the network can monitor the validity of the timing advance and can indicate to the UE to re-acquire the timing advance from the target cell.

When the UE is prepared with multiple CFRA preamble(s) for multiple target cells, the RAN node can indicate to which specific cell the UE should acquire timing advance using the scheduling gaps. In the case of lower layer mobility (LLM), the specific target can also be indicated, for example as an index, using the same MAC control element (CE) in downlink (DL), that is used to indicate when the UE should perform target synchronization.

The UE may indicate to the network that among multiple configured target cells, the UE may acquire timing advance for a specific target cell. Such a selection by the UE may be related to the RACH occasion configuration and the UL gap configuration of the UE. Responsive to indication from the UE, the network may re-configure the UL gap for the UE.

Multiple target cells may align their RACH occasions or preamble allocation for a RACHless timing advance acquisition procedure. This alignment may be achieved via dedicating a RACH occasion for timing advance acquisition for RACHless. The allocated CFRA preamble by one target cell may be indicated to other target cells. In case this CFRA preamble is not allocated by other target cells for other UEs, the same preamble maybe allocated by the other target cells to achieve a synchronized CFRA preamble in the same RACH occasion. Hence, the same RACH preamble transmission can be used to acquire the TA of multiple target cells. In this case, there may be no need for dedicated RACH preamble transmission for each target cell.

In advanced mobility mechanisms like CHO and lower layer mobility, where multiple target cell configurations may be provided to the UE in advance, the gNB-DU may indicate the target cell ID to be synchronized to the UE using a DL MAC CE command. Synchronizing can involve identifying the target cell, searching the RACH occasion, performing RACH, and the like.

Typically, in the gNB there may be multiple UEs connected to the same cell and hence one UE may not be scheduled continuously. For example, voice UE may be scheduled with 20 ms interval and basic non-guaranteed bit rate (GBR) data may be scheduled even less frequently. From the UE point of view the relevant point is in interruption time between scheduling. If the handover can be prepared between scheduling occasion(s), then the UE can basically do zero or almost zero interruption handover. If the UE does not know when the UE's going to be scheduled the next time, it may be challenging for the UE to plan ahead to prepare for handover.

Estimation of scheduling gaps can be done in a straightforward way for UEs with a single data radio bearer (DRB) or single service.

For UEs with multiple DRBs, the gNB can determine the scheduling gap based on the scheduling interval of the most frequently scheduled DRB. For example, if a UE has DRB A and DRB B with scheduling intervals of 10 ms and 2 ms respectively, then the scheduling gap configured to the UE may be 2 ms.

The gNB can classify UEs into different categories based on scheduling gaps of the UE's DRBs. Each category may be given an index.

Further, this scheduling gap can be configured to the UE during RRC Reconfiguration, for example at DRB setup, release, or the like. Any change in the scheduling gap due, for example, to DRB addition, release or change of QoS parameters, such as QoS flow identifier (QFI), can be indicated to the UE using a DL MAC CE command.

The UE may also indicate the completion of synchronization with the target cell using a MAC CE command in UL.

In certain embodiments, the UE may be configured via RRC with a dynamic gap configuration. The dynamic gap configuration may include mapping options about the gap length and also optionally synchronization information about possible handover candidates. The mapping may map to such aspects as gap length, cell identifiers, or the like. The gNB may configure the dynamic gap configuration for those UEs are which configured with, for example, L1/L2 handover. When gNB performs scheduling for the UE, the gNB can indicate after each data packet or scheduling interval when a next scheduling is planned to occur. This indication from scheduling about next scheduling can be mapping to the dynamic gap option that was given for the UE with RRC

The gNB may also use the gNBs internal algorithm to optimize this scheduling whenever needed. The gNB can indicate the scheduling interval to the UE in a MAC message together with scheduling. When UE receives the info about the next scheduling, the UE can map the received information to preconfigured RRC values. Another option is that the network can make the mapping and can indicates which preconfigured option is used. Either way, the UE can receive information about how much time the UE has. The UE can use this time to search RACH parameters from neighboring cells. When the time is going to expire, the UE can come back to the source cell, store a completed search result, and can continue to receive next data and a new gap. The UE can continue this procedure until the UE has been able to find strong neighbors and clarified RACH occasions of the cell or the defined procedures. Once all the defined procedures are clarified, the UE can leave from the source cell at the correct moment.

The network can estimate and define the length of the gap separately for each scheduling round or alternatively for longer period. With certain embodiments, the handover interruption time can be optimized even to zero in the best case, as the UE may know the moment when the UE can receive the last packet from source cell, move to a new cell, and receive the very next data packet.

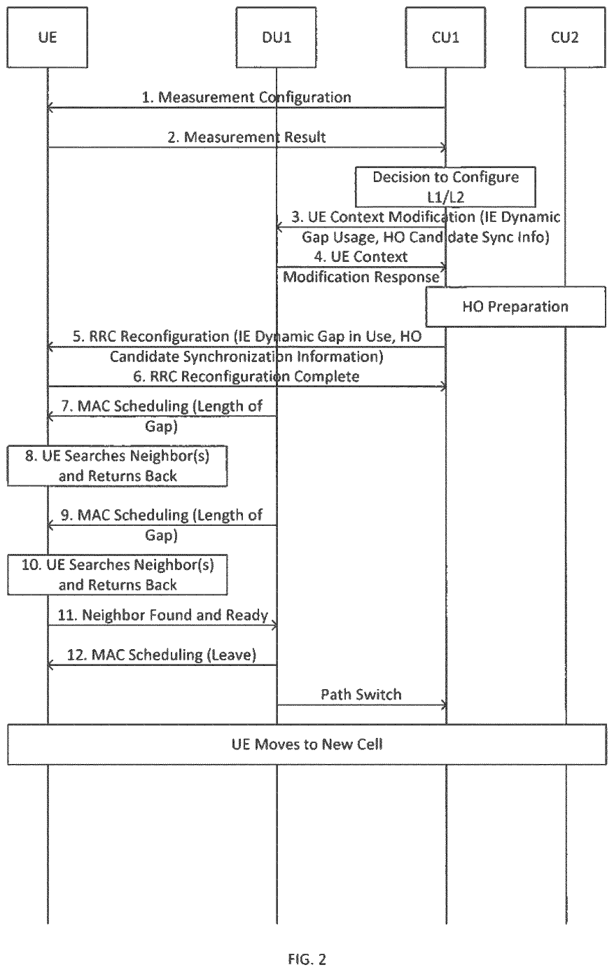

FIG. 2 illustrates a signaling flow diagram to configure a dynamic gap for a user equipment, according to certain embodiments. As shown in FIG. 2, at 1 the UE can be configured to perform measurement of neighbors. At 2, the UE can send measurement result(s). At 3, the CU can configure L1/L2 HO and can indicate for the DU that dynamic gap is in use. Optionally this could also include neighboring synchronization info to optimize scheduling occasion(s). At 4, there can be a UE context modification response from the DU to the CU.

At 5, the CU can configure the UE with RRC reconfiguration and can include usage of dynamic gap and information about neighboring cell synchronization for those neighbors that the CU knows. The UE can use this info to optimize neighboring search procedure. At 6, the UE can provide an RRC reconfiguration response.

At 7, the DU can schedule the UE and can indicate with the an information element (IE) how much time the UE has to search neighboring cells. At 8, the UE can synchronize to the neighboring cell(s) and/or search RACH occasion. At 9, the UE can return to the source cell to receive a next scheduling and can again receive an indication of the length of the next gap before further scheduling. At 10, the UE can continue the search and synchronization procedure.

At 11, if the UE can find neighbor with all needed parameters it indicates this to the source cell. At 12, the UE may still optionally receive last data scheduling in the cell. Once that last data scheduling in the cell is completed, the UE can move to the prepared new cell where the UE can receive the next data scheduling. This kind of synchronized move may also allow keeping UE scheduling interval almost the same and have as little as zero interruption time.

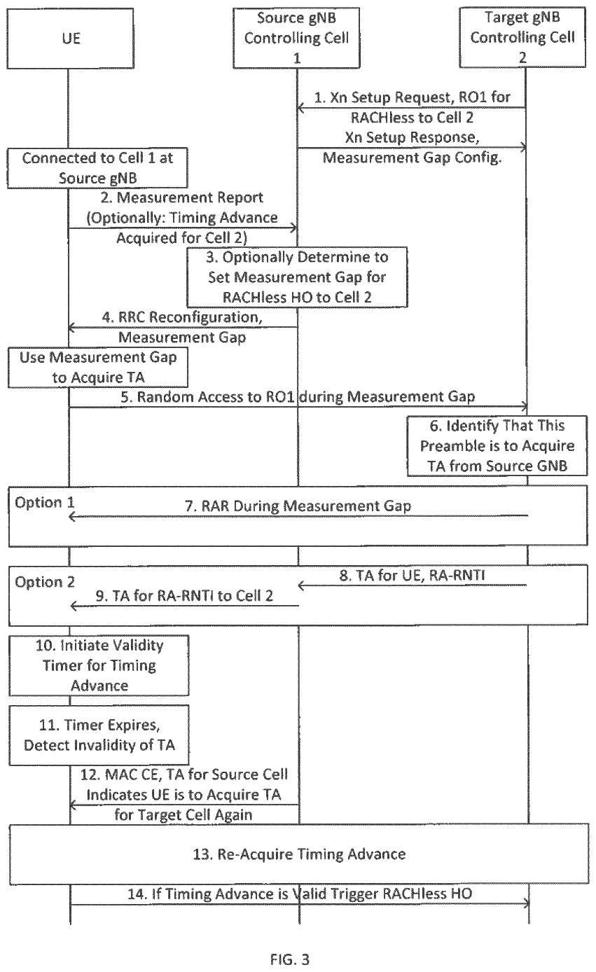

FIG. 3 illustrates a signal flow diagram illustrating various aspects of certain embodiments. As shown in FIG. 3, at 1, during Xn setup request, the RAN Nodes such as source gNB and target gNB, can exchange the RACH occasion or RACH configuration allocated for the procedures of certain embodiments. In the Xn Setup response, the source node may indicate the measurement gap configuration to be configured to the UE. This information can be used by the target node to schedule a random access response if necessary to the UE.

At 2, the source gNB can receive a measurement report according to a previously measurement configuration that is provided to the UE. This measurement report can be a cell preparation event. Optionally, in this measurement report the UE may indicate that a timing advance acquisition is requested for the reported cell.

At 3, responsive to the UE indicating the need to acquire timing advance. The network determines that UE needs to be configured with the measurement gap to enable random access to the RACH occasion of the neighbor cell. Similarly, in an alternative option, the network may determine that the cell 2 that is indicated by the measurement report may require the acquisition of timing advance. This may lead to the network determining to configure measurement gap for the UE.

At 4, the network can configure the UE with a measurement gap for a procedure according to certain embodiments. The measurement gap can be indicated to be used to acquire timing advance. Optionally, the configuration may indicate to the UE to acquire timing advance from a specific cell.

At 5, 6, 7, 8, and 9, the UE may initiates random access to the target cell, and interact with cell 2. If the UE uses a special RACH occasion or a special preamble, which can be allocated procedure 1, the

target node may determine to send a random access response to the UE using the gap allocated in procedure 1. Alternatively, the target node may determine to indicate the timing advance to the UE over the source gNB. Both the timing advance (TA) and the TA radio network temporary identifier (TA-RNTI) can be indicated to the UE to avoid false timing advance indications.

At 10, the UE can initiate a validity timer for TA. The validity timer can be configured to the UE with the timing advance information. Alternatively, the validity timer can be a fixed configuration, for example established by a standard or according to a user equipment implementation.

At 11, in one case the validity timer may expire and the UE may re-initiate the TA acquisition.

At 12 and 13, in another case, the network may determine the TA is not valid and may indicate UE to re-initiate TA acquisition.

At 14, in one case, if the TA is valid, UE may conduct RACHless HO.

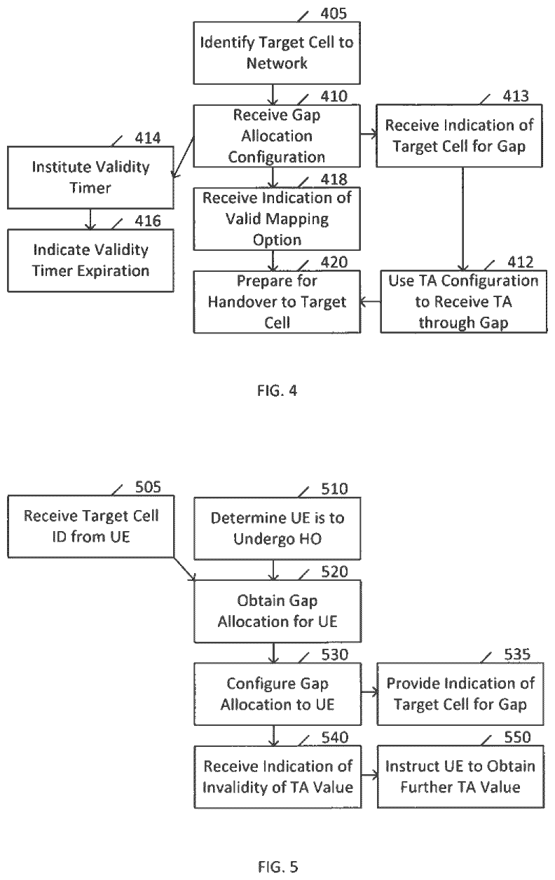

FIG. 4 illustrates a method according to certain embodiments. The method of FIG. 4 may be performed by a user equipment, terminal device, or the like. As shown in FIG. 4, at 410, a method can include receiving, at a terminal device, a gap allocation configuration from a network. The method can also include, at 420, preparing, by the terminal device, for a handover to a target cell during a gap according to the gap allocation. The gap allocation configuration can further include synchronization information about possible handover candidates. The preparing comprises performing synchronization to the target cell before being handed over to the target cell.

The receiving the gap allocation at 410 can include receiving a timing advance configuration to obtain timing advance for the target cell.

The method of FIG. 4 can also include, at 412, using, by the terminal device, the timing advance configuration to receive timing advance from the target cell through the allocated gap.

The method can also include, at 414, initiating, at the terminal device, a validity timer associated with the timing advance upon receiving the timing advance.

The method can further include, at, 416, indicating invalidity of the timing advance to the network upon expiration of the validity timer.

At 413, the method can include receiving, at the terminal device from the network, an identification of the target cell to which the timing advance acquisition or a further timing advance acquisition is applicable. For example, a further timing advance may be obtained after the initial timing advance is no longer valid. Thus, the terminal device can receive an indication from the RAN node as to which specific cell the terminal device should acquire timing advance using the scheduling gaps. In the case of LLM, this can also be received, for example as an index, using the same MAC CE in DL that indicates when the terminal device should perform target synchronization.

A dedicated random access channel occasion or preamble allocation can be provided with the timing advance configuration to accommodate timing advance acquisition.

At 405, the method can include providing, by the terminal device, an identification of a target cell to the network. The gap allocation can be configured according to the target cell identified to the network. The gap allocation configuration can include mapping options about a gap length, as described above.

The method can also include, at 418, receiving, at the terminal device subsequent to receiving the mapping options, an indication of a valid mapping option of the mapping options. The preparing for the handover at 420 can be performed based on indication of the valid mapping option.

FIG. 5 illustrates another method according to certain embodiments. The method of FIG. 5 may be performed by an access network element, such as a gNB or the like. The method of FIG. 5 may performed alone or in combination with the method of FIG. 4.

As shown in FIG. 5, a method can include, at 510, determining, at an access network element, that a user equipment is to undergo handover to a target cell.

The method can also include, at 520, obtaining, by the access network element, a gap allocation to be configured to the user equipment based on the determination. The obtaining can include obtaining the gap allocation from a source distributed unit or from a peer base station.

The method can further include, at 530, configuring, by the access network element, the gap allocation to the user equipment. The configuring the gap allocation to the user equipment can also include configuring a timing advance for the target cell to the user equipment. The method can further include, at 535, identifying, by the access network element to the user is equipment, the target cell to which the timing advance acquisition or the further timing advance acquisition is applicable. A dedicated random access channel occasion or preamble allocation can be provided to accommodate timing advance acquisition. Thus, the RAN node can indicate to which specific cell the user equipment should acquire timing advance using the scheduling gaps. In the case of LLM, this can also be indicated, for example as an index, using the same MAC CE in downlink that is used to indicate when the user equipment should perform target synchronization.

The method can additionally include, at 540, receiving, by the access network element, an indication of invalidity of the timing advance from the user equipment. The method can also include, at 550, instructing, responsive to the indication, the user equipment to obtain the further timing advance from the target cell.

At 505, the method can include receiving, by the access network element from the user equipment, an identification of a target cell, wherein the gap allocation is configured according to the target cell identified by the user equipment.

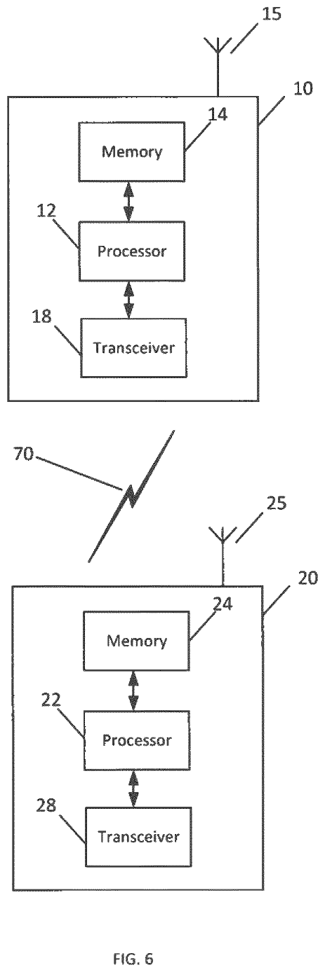

FIG. 6 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus may be gNB or other similar radio node, for instance.

It should be understood that, in some example embodiments, apparatus may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 6.

As illustrated in the example of FIG. 6, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 6, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to a handover interruption time reduction through data reception on a source cell during a handover procedure.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein. The term “non-transitory,” as used herein, may correspond to a limitation of the medium itself (i.e., tangible, not a signal) as opposed to a limitation on data storage persistency (e.g., RAM vs. ROM).

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 2-5, or any other method described herein. In some embodiments, as discussed herein, apparatus 10 may be configured to perform a procedure relating to providing a handover interruption time reduction through data reception on a source cell during a handover procedure, for example.

FIG. 6 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 6.

As illustrated in the example of FIG. 6, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 2-5, or any other method described herein. For example, in an embodiment, apparatus 20 may be controlled to perform a process relating to providing a handover interruption time reduction through data reception on a source cell during a handover procedure, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may enable operation of a 5-MHz UE with configuration of CORESETs that are wider than 5 MHz through the use of a supplementary CORESET. Moreover, certain embodiments may enable overcoming loss of frequency diversity for PDCCH in supplementary CORESET that may occur with some configurations of CCE-to-REG mapping through configurable REG offset. Two parameters, N_{RB}^{BLOCK} and n_{offset}, may capture the characteristics of the BW reduction for eRedCap UE.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

PARTIAL GLOSSARY:

| | |
|---|---|
| HO | Handover |
| UP | User Plane |
| CP | Control Plane |
| RACH | Random Access Channel |
| gNB | Next Generation Node B. |
| L1 | Layer 1 |
| L2 | Layer 2 |
| CU | Central Unit |
| DU | Distributed Unit |
| CHO | Conditional Handover |
| MAC | Medium Access Control |
| PS | Probabilistic Scheduler |
| CFRA | Contention Free Random Access |
| RACH | Random Access Channel |
| UE | User Equipment |
| NG | Next Generation |

1.-28. (canceled)

29. A terminal device, comprising:
at least one processor; and
at least one memory storing instructions that, when executed by the at least one processor, cause the terminal device at least to perform:
receiving a gap allocation configuration from a network, wherein the gap allocation configuration comprises mapping options about a gap length;
receiving an indication of a valid mapping option of the mapping options;
receiving a timing advance configuration to obtain timing advance for a target cell;
using the timing advance configuration to receive a timing advance from the target cell through the allocated gap;
initiating a validity timer associated with the timing advance upon receiving the timing advance;
indicating invalidity of the timing advance to the network upon expiration of the validity timer; and
preparing for a handover to a target cell during a gap according to the gap allocation, wherein the preparing for the handover is performed based on indication of the valid mapping option.

30. The terminal device of claim 29, wherein the instructions further cause the terminal device to perform:
receiving, from the network, an identification of the target cell to which the timing advance acquisition is applicable.

31. The terminal device of any of claim 30, wherein a dedicated random access channel occasion or preamble allocation is provided with the timing advance configuration to accommodate timing advance acquisition.

32. The terminal device of claim 31, wherein the instructions further cause the terminal device to perform:
providing an identification of a target cell to the network, wherein the gap allocation is configured according to the target cell identified to the network.

33. The terminal device of claim 32, wherein the gap allocation configuration further comprises synchronization information about possible handover candidates.

34. The terminal device of claim 33, wherein the preparing comprises performing synchronization to the target cell before being handed over to the target cell.

35. The terminal device of claim 34, wherein the terminal device is configured to use the gap to search for a random access channel occasion of the target cell.

36. The terminal device of claim 35, wherein the terminal device is configured to use the gap to do a random access procedure with the target cell.

37. The terminal device of claim 36, wherein the terminal device is configured to indicate to source node that a source cell can initiate the handover and can stop user plane procedures.

38. A system comprising:
a terminal device;
at least one processor; and
at least one memory storing instructions that, when executed by the at least one processor, cause the terminal device at least to perform:
receiving a gap allocation configuration from a network, wherein the gap allocation configuration comprises mapping options about a gap length;
receiving an indication of a valid mapping option of the mapping options;
receiving a timing advance configuration to obtain timing advance for a target cell;
using the timing advance configuration to receive a timing advance from the target cell through the allocated gap;
initiating a validity timer associated with the timing advance upon receiving the timing advance;
indicating invalidity of the timing advance to the network upon expiration of the validity timer; and
preparing for a handover to a target cell during a gap according to the gap allocation, wherein the preparing for the handover is performed based on indication of the valid mapping option.

39. The system of claim 38, wherein the instructions further cause the terminal device to perform:
receiving, from the network, an identification of the target cell to which the timing advance acquisition is applicable.

40. The system of claim 39, wherein a dedicated random access channel occasion or preamble allocation is provided with the timing advance configuration to accommodate timing advance acquisition.

41. The system of claim 40, wherein the instructions further cause the terminal device to perform:
providing an identification of a target cell to the network, wherein the gap allocation is configured according to the target cell identified to the network.

42. The system of claim 41, wherein the gap allocation configuration further comprises synchronization information about possible handover candidates.

43. The system of claim 42, wherein the preparing comprises performing synchronization to the target cell before being handed over to the target cell.

44. The system of claim 43, wherein the terminal device is configured to use the gap to search for a random access channel occasion of the target cell.

45. The system of claim 44, wherein the terminal device is configured to use the gap to do a random access procedure with the target cell.

46. The system of claim 45, wherein the terminal device is configured to indicate to source node that a source cell can initiate the handover and can stop user plane procedures.

47. A method comprising:
receiving, by a terminal device, a gap allocation configuration from a network, wherein the gap allocation configuration comprises mapping options about a gap length;
receiving an indication of a valid mapping option of the mapping options;
receiving a timing advance configuration to obtain timing advance for a target cell;
using the timing advance configuration to receive a timing advance from the target cell through the allocated gap;
initiating a validity timer associated with the timing advance upon receiving the timing advance;
indicating invalidity of the timing advance to the network upon expiration of the validity timer; and
preparing for a handover to a target cell during a gap according to the gap allocation, wherein the preparing for the handover is performed based on indication of the valid mapping option.

48. The method of claim 47, further comprising:
receiving, from the network, an identification of the target cell to which the timing advance acquisition is applicable;
wherein a dedicated random access channel occasion or preamble allocation is provided with the timing advance configuration to accommodate timing advance acquisition.
